(19) United States
(12) Patent Application Publication
(10) Pub. No.: US 2024/0213789 A1
(43) Pub. Date: Jun. 27, 2024

(54) Multifunctional mobile power supply

(71) Applicant: Chun Ye, Shenzhen (CN)

(72) Inventor: Chun Ye, Shenzhen (CN)

(21) Appl. No.: 18/435,013

(22) Filed: Feb. 7, 2024

(51) Int. Cl. H02J 7/00; H02J 1/00

(52) U.S. Cl. CPC H02J 7/0044; H02J 1/001; H02J 7/0013

(57) ABSTRACT

The present disclosure relates to the technical field of mobile power supplies, and provides a multifunctional mobile power supply. The multifunctional mobile power supply includes a power supply host machine. When the removable functional modules with different functions are embedded in the power supply host machine for charging, the mobile power supply charges the removable functional modules and also has the functions of the removable functional modules, so that one power supply host machine can be matched with the removable functional modules with different functions to obtain mobile power supplies with different functions.

### TECHNICAL FIELD

Each embodiment of the present disclosure relates to the technical field of mobile power supplies, in particular to a multifunctional mobile power supply.

### BACKGROUND

The mobile power supply is a power supply convenient for charging management, and can be used for portably charging removable functional modules at any time. In the prior art, the mobile power supply usually includes a power supply body. A PCB (Printed circuit board) control board and a battery unit are assembled inside the power supply body, and the battery unit is electrically connected with the PCB control board. A USB (Universal Serial Bus) port and charging indicator lamps are arranged on the outer side of the power supply body. A user can charge the removable function modules by connecting the USB port and the removable function modules through USB cables. At the same time, the user can also judge the electric quantity of the mobile power supply and whether the removable function modules are being charged through the charging indicator lamps. The existing mobile power supply is mainly used for charging. After the product is designed, the product function is uniquely determined, and the user cannot freely combine mobile power supplies with different functions according to own demands, resulting in a single function of the mobile power supply. Moreover, most of the existing mobile power supplies need to be connected with a charging interface in a charging bin and the removable functional modules outside the mobile power supply through charging cables, which excessively depends on the charging cables. Another placement positions of the removable functional modules are needed, which is not conducive to charging management.

To sum up, the existing mobile power supply has some technical problems, such as charging depends on charging cables, the function is single, and charging management is not facilitated.

### SUMMARY

Aiming at the problems and shortcomings of the existing mobile power supply, the present disclosure provides a multifunctional mobile power supply. The functions of the mobile power supply are increased, and charging management is facilitated.

The multifunctional mobile power supply provided by the present disclosure includes a power supply host machine. The power supply host machine includes an embedded power supply bin, and the embedded power supply bin includes a charging interface in a charging bin. The embedded power supply bin is used for providing embedded charging for a removable functional module. The removable functional module includes a power supply connected spring needle groove, and when the power supply connected spring needle groove is matched and plugged with the charging interface in the charging bin, the removable functional module is embedded into the embedded power supply bin for charging and can work independently.

Compared with the prior art, the present disclosure has the following beneficial effects.

The present disclosure provides a multifunctional mobile power supply, including a power supply host machine. The power supply host machine includes an embedded power supply bin, and the embedded power supply bin includes a charging interface in a charging bin. The embedded power supply bin is used for providing embedded charging for a removable functional module. The removable functional module includes a power supply connected spring needle groove, and when the power supply connected spring needle groove is matched and plugged with the charging interface in the charging bin, the removable functional module is embedded into the embedded power supply bin for charging and can work independently. In this way, the removable functional module and the mobile power supply are connected without the need of a charging cable, so that charging management is facilitated. When the removable functional modules with different functions are embedded in the power supply host machine for charging, the mobile power supply charges the removable functional modules and also has the functions of the removable functional modules, so that one power supply host machine can be matched with the removable functional modules with different functions to obtain mobile power supplies with different functions.

### BRIEF DESCRIPTION OF THE DRAWINGS

Attached figures, which form a part of the description and are provided for further understanding of the present disclosure, show the preferred embodiments of the present disclosure, and explain the principle of the present disclosure together with the description, but not by way of limitation with regard to the claimed disclosure. Some specific embodiments of the present disclosure are hereinafter described in detail in an exemplary or non-restrictive mode with reference to the attached figures. The same reference signs in the attached figures indicate the same or similar components or parts. Those skilled in the art should understand that the attached figures are not necessarily drawn to scale. In the attached figures,

FIG. 1 is a structural schematic diagram of a multifunctional mobile power supply in the embodiment of the present disclosure. FIG. 2 is a schematic diagram of an assembly structure when a removable functional module is a spliced panel light module in the embodiment of the present disclosure. FIG. 3 is a schematic diagram of an assembly structure when a removable functional module is a spliced spotlight module in the embodiment of the present disclosure. FIG. 4 is a schematic diagram of an assembly structure when a removable functional module is a spliced mobile power supply module in the embodiment of the present disclosure. FIG. 5 is a schematic diagram of an assembly structure of a spliced mobile power supply module in the embodiment of the present disclosure. FIG. 6 is a schematic diagram of an assembly structure when a removable functional module is a spliced USB module in the embodiment of the present disclosure. FIG. 7 is a schematic diagram of an assembly structure when a removable functional module is a spliced Bluetooth audio in the embodiment of the present disclosure. FIG. 8 is a structural schematic diagram of a multifunctional mobile power supply embedded with a spliced mobile power supply module for charging in the embodiment of the present disclosure. FIG. 9 is a structural schematic diagram of a multifunctional mobile power supply embedded with a spliced spotlight module for charging in the embodiment of the present disclosure. FIG. 10 is a structural schematic diagram of a multifunctional mobile power supply embedded with a spliced Bluetooth audio for charging in the embodiment of the present disclosure. FIG. 11 is another decomposed structural schematic diagram of a multifunctional mobile power supply in the embodiment of the present disclosure. FIG. 12 is a decomposed structural schematic diagram of a spliced lamp module support in the embodiment of the present disclosure.

Reference signs in attached figures:
1, power supply host machine; 11, embedded power supply bin; 12, charging interface in charging bin; 13, bin exit button; 14, bin exit spring; 15, loudspeaker; 16, microphone; 17, guide limit boss; 18, limit spring; 19, support plugged position;
2, removable functional module; 20, power supply connected spring needle groove; 200, power supply connected spring needle; 201, power supply connected groove; 21, guide limit groove;
3, lamp module body; 31, light-emitting device; 32, lamp module boss; 33, lamp module groove;
4, power supply module body; 41, boss surface; 42, charging hole; 43, charging spring plate;
50, support body; 500, segmented body; 501, adjustment mounting head; 51, lamp module mounting platform; and 510, platform groove.

### DETAILED DESCRIPTION OF THE EMBODIMENTS

To make a person skilled in the art understand the technical solutions in the present disclosure better, the following clearly and completely describes the technical solutions in the embodiments of the present disclosure with reference to the attached figures in the embodiments of the present disclosure.

### Embodiment I

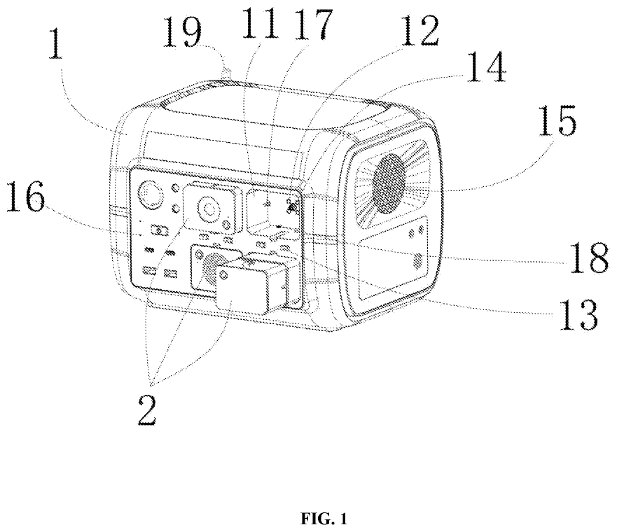

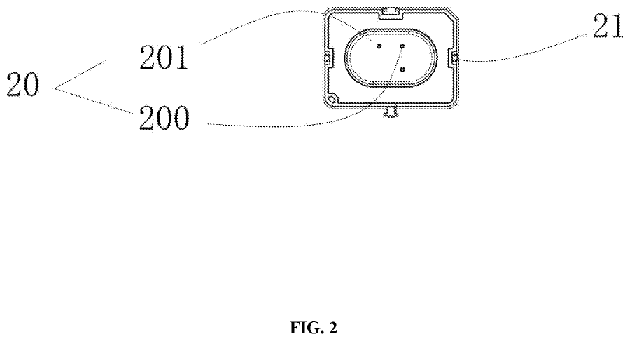

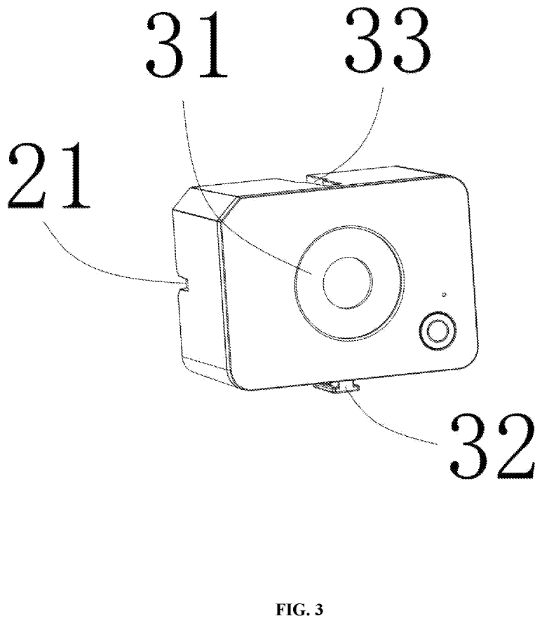

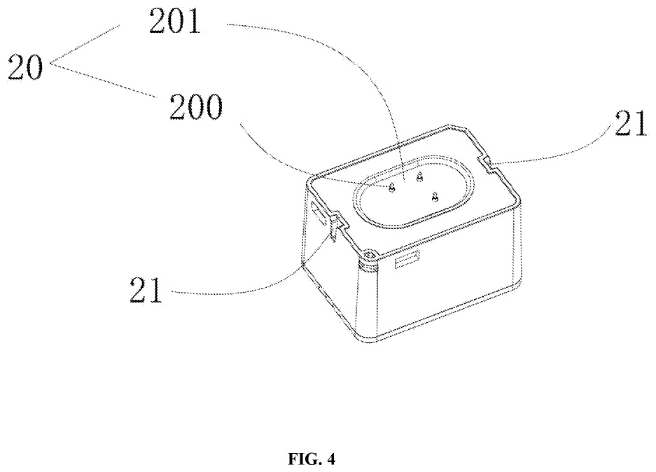

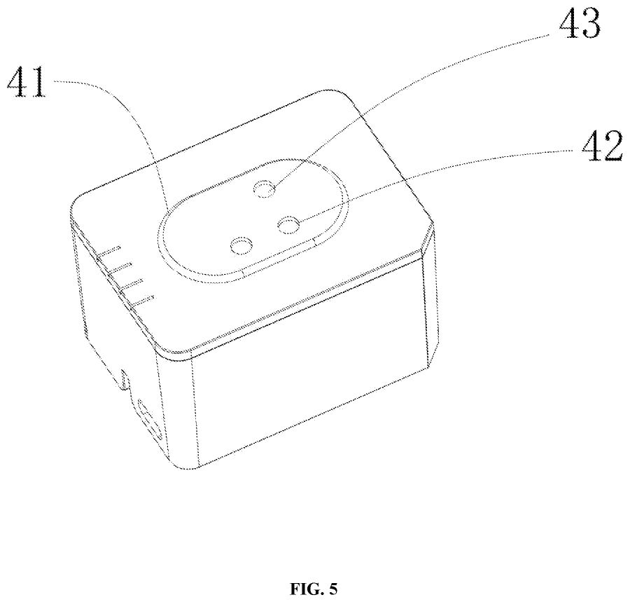

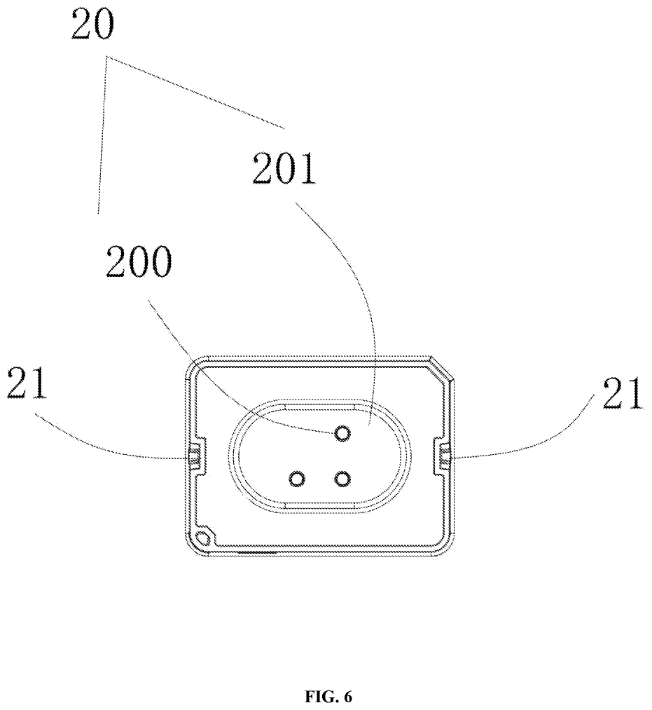

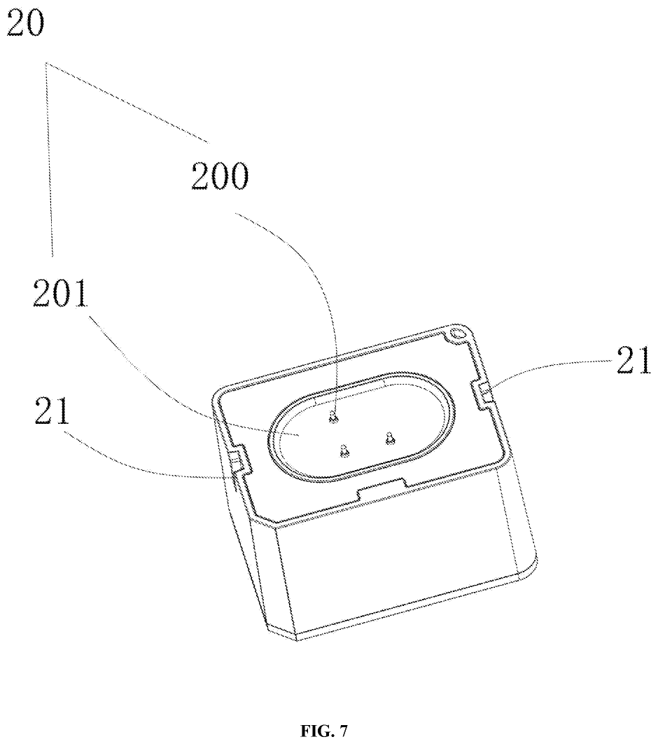

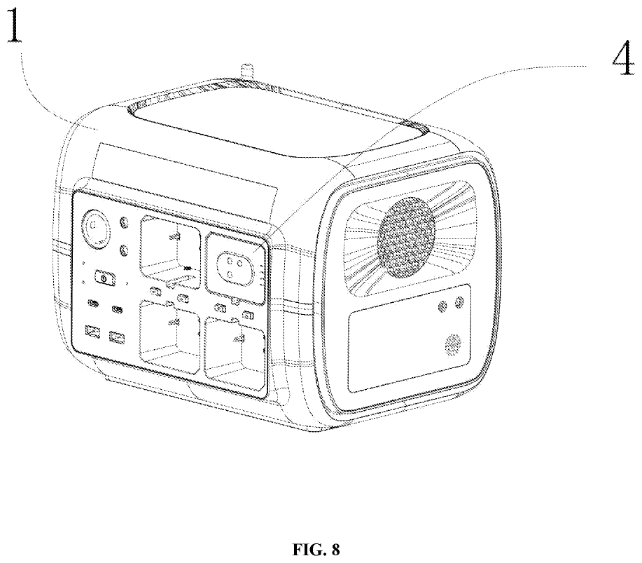

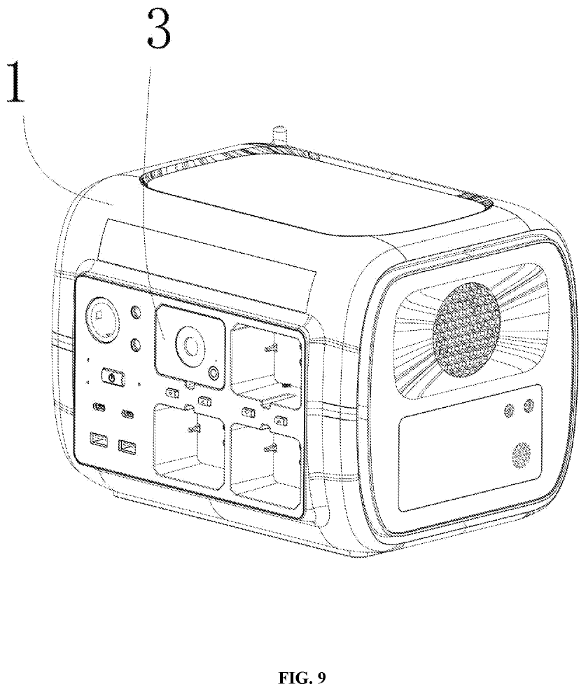

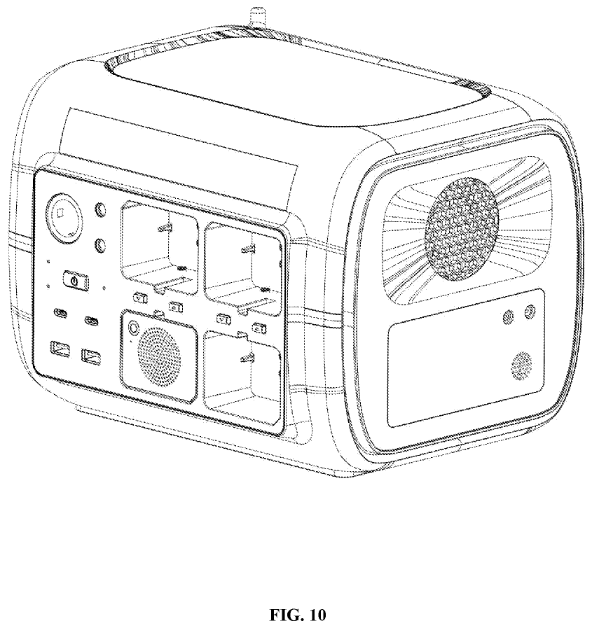

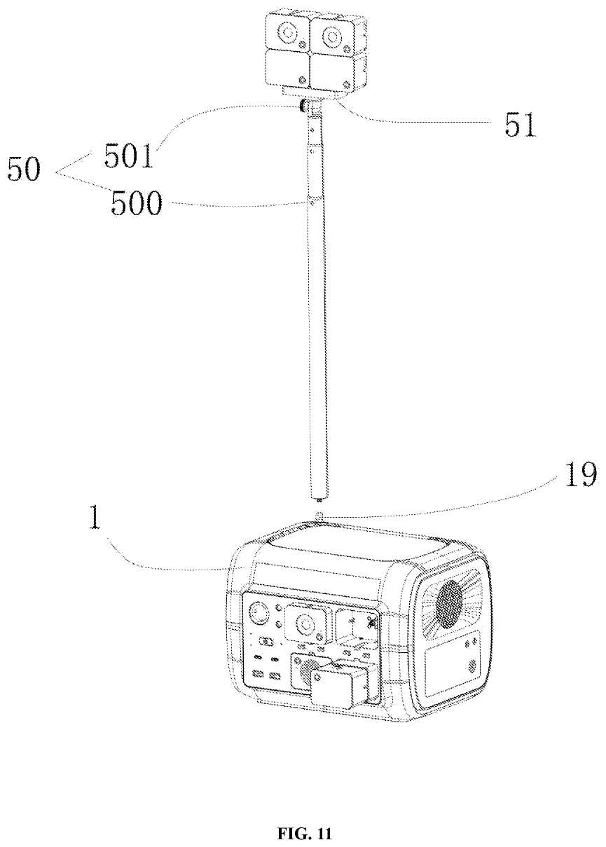

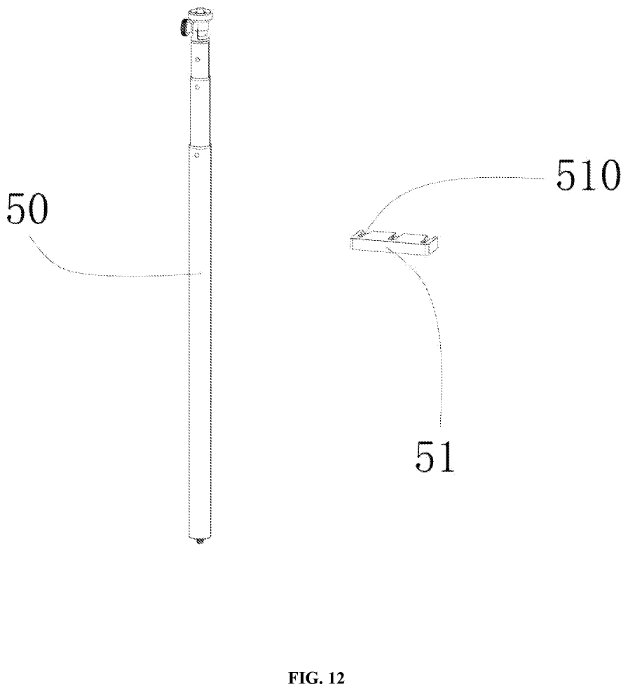

Referring to FIG. 1 to FIG. 12, the embodiment of the present disclosure provides a multifunctional mobile power supply, including:
a power supply host machine 1, wherein the power supply host machine 1 includes an embedded power supply bin 11, and the embedded power supply bin 11 includes a charging interface 12 in a charging bin; the embedded power supply bin 11 is used for providing embedded charging for a removable functional module 2; and the removable functional module 2 includes a power supply connected spring needle groove 20, and when the power supply connected spring needle groove 20 is matched and plugged with the charging interface 12 in the charging bin, the removable functional module 2 is embedded into the embedded power supply bin 11 for charging and can work independently. Wherein, the power supply connected spring needle groove 20 can include power supply connected spring needles 200 and a power supply connected groove 201; and the power supply connected spring needles 200 are distributed inside the power supply connected groove 201.

What needs illustration is that in the embodiment, the embedded power supply bin 11 includes a charging interface 12 in a charging bin. The embedded power supply bin 11 is used for providing embedded charging for a removable functional module 2. The removable functional module 2 includes a power supply connected spring needle groove 20. The power supply connected spring needle groove 20 can be matched and plugged with the charging interface 12 in the charging bin, so that the removable functional module 2 is charged. The removable functional module 2 and the mobile power supply are connected without the need of a charging cable, so that charging management is facilitated. When the removable functional modules 2 with different functions are embedded in the power supply host machine 1 for charging, the mobile power supply 2 charges the removable functional modules 2 and also has the functions of the removable functional modules, so that one power supply host machine 1 can be matched with the removable functional modules 2 with different functions to obtain mobile power supplies with different functions.

In some preferred embodiments, the embedded power supply bin 11 refers to a plurality of embedded power supply bins 11. The embedded power supply bins 11 are distributed on one side of the power supply host machine 1 at intervals. Body structures of the removable functional modules 2 are completely embedded into the embedded power supply bins, or the body structures of the removable functional modules 2 are partially embedded into the embedded power supply bins 11. What needs illustration is that the embedded power supply bin 11 refers to a plurality of embedded power supply bins 11. The embedded power supply bins 11 are distributed on one side of the power supply host machine 1 at intervals, so that one power supply host machine I can be matched with the removable functional modules 2 with different functions to obtain mobile power supplies with different functions. In addition, the body structures of the removable functional modules 2 are all embedded into the embedded power supply bins 11, so that the removable functional modules 2 and the power supply host machine 1 can be integrated to realize hidden charging and function combination.

In some improved embodiments, when the body structures of the removable functional modules 2 are selected to be completely embedded into the embedded power supply bins 11 for charging, the power supply host machine 1 also includes bin exit button 13 ejection mechanisms, and the bin exit button 13 ejection mechanism is arranged at the position of each embedded power supply bin 11. The bin exit button 13 ejection mechanism includes a bin exit button 13 and a bin exit spring 14. The bin exit button 13 is arranged at an opening of the embedded power supply bin 11, the bin exit spring 14 is arranged at the position of the charging interface 12 in the charging bin, and the bin exit button 13 is connected with the bin exit spring 14 through an internal groove of the embedded power supply bin 11. What needs illustration is that in the embodiment, when the body structures of the removable functional modules 2 are selected to be embedded into the embedded power supply bins 11 for charging, the bin exit spring 14 is pushed by the bin exit button 13 by pressing the bin exit button 13, and the removable functional module 2 is ejected from the position of the charging interface 12 in the charging bin by the bin exit spring 14, so that charging management is facilitated. In addition, the body structures of the removable functional modules 2 are partially embedded into the embedded power supply bins 11, part of the body structures of the removable functional modules 2 are exposed outside the power supply host machine 1 and are convenient to take.

In some preferred embodiments, the removable functional modules 2 include a spliced mobile power supply module, a spliced panel light module, a spliced spotlight module, a spliced Bluetooth audio and a spliced USB (Universal Serial Bus) module. What needs illustration is that the removable functional module 2 is modular electronic equipment which has independent functions and can be embedded in the embedded power supply bin 11 for charging. For example, the removable functional modules 2 include a spliced mobile power supply module, a spliced panel light module, a spliced spotlight module, a spliced Bluetooth audio, a spliced USB module and the like. When the embedded power supply bin 11 refers to a plurality of embedded power supply bins 11, a spliced mobile power supply module, a spliced panel light module, a spliced spotlight module, a spliced Bluetooth audio, a spliced USB module and the like are embedded in the embedded power supply bins, so that centralized charging is realized, and the functions of the mobile power supply are greatly increased. One power supply host machine I can be freely matched with various functional functions to form a mobile power supply with brand-new functions. What needs illustration is that splicing can refer to a combination mode in which the removable functional modules 2, such as a mobile power supply module, a panel light module, a spotlight module, a Bluetooth audio module and a USB module, can be freely plugged with the embedded power supply bins 11 of the power supply host machine 1 for charging to form a mobile power supply with new functions. Splicing can also refer to a combination mode in which the mobile power supply module can be magnetically attracted with the removable functional modules 2 such as a panel light module, a spotlight module, a Bluetooth audio module and a USB module for charging. In addition, in a spliced panel light module and a spliced spotlight module, splicing can also refer to a combination mode in which the panel light module and the spotlight module can be freely combined to form a lamp with a larger irradiation area.

In some preferred embodiments, the multifunctional mobile power supply also includes an audio module audio module. The audio module includes an audio control circuit and a loudspeaker 15. The audio control circuit is integrated on a control circuit board of the power supply host machine 1 and electrically connected with the loudspeaker 15. The loudspeaker 15 is arranged on the inner side of the power supply host machine 1 and communicates with an outer wall of the power supply host machine 1. In some preferred embodiments, the multifunctional mobile power supply also includes an intelligent speech recognition module. The intelligent speech recognition module includes a microphone 16 and an intelligent speech recognition circuit. The intelligent speech recognition circuit is integrated on the control circuit board of the power supply host machine 1 and electrically connected with the microphone 16. The microphone 16 is arranged on the inner side of the power supply host machine 1 and communicates with an outer wall of the power supply host machine 1. Further, the intelligent speech recognition circuit includes an intelligent speech recognition chip. The intelligent speech recognition chip prestores an instruction for controlling to open or close the charging interface 12 in the charging bin. The microphone 16 receives a speech signal that a user controls to open or close the charging interface 12 in the charging bin and transmits the speech signal to the intelligent speech recognition chip, and the intelligent speech recognition chip controls to open or close the charging interface 12 in the charging bin after the speech signal is matched with the instruction of opening or closing the charging interface 12 in the charging bin. Further, when the control circuit board of the power supply host machine 1 obtains a signal that the removable functional module 2 is connected or disconnected with the charging interface 12 in the charging bin, ID (identity) information of the removable functional module 2 that the charging interface 12 in the charging bin is connected or disconnected is judged, and the audio module is controlled to broadcast a connection state or a disconnection state of the removable functional module 2 according to the judged ID information. What needs illustration is that when the embedded power supply cabins 11 are embedded in the removable functional modules 2 for charging, the management for each removable functional module 2 becomes difficult. In the embodiment, the ID information of the removable functional module 2 that the charging interface 12 in the charging bin is connected or disconnected is judged, and the audio module is controlled to broadcast a connection state or a disconnection state of the removable functional module 2 according to the judged ID information, so that the charging management can become simple and clear. For example, the charging connection of the Bluetooth audio is broadcast, and the charging disconnection of the USB module is broadcast.

In some preferred embodiments, the removable functional module 2 is cuboid-shaped, and the embedded power supply bin 11 is a cuboid-shaped empty bin. What needs illustration is that in the embodiment, the removable functional module 2 is cuboid-shaped, and the embedded power supply bin 11 is a cuboid-shaped empty bin, so that it can be ensured that the body structures of various removable functional modules 2 can be adapted to be embedded in the embedded power supply bins 11 for charging.

In some preferred embodiments, the removable functional module 2 also includes a guide limit groove 21, and the guide limit groove 21 is arranged on the outer side of the removable functional module 2. The embedded power supply bin 11 is internally provided with a guide limit boss 17. The removable functional module 2 is embedded into the embedded power supply bin 11, and when the power supply connected spring needle groove 20 is matched and plugged with the charging interface 12 in the charging bin, the guide limit groove 21 is matched and plugged with the guide limit boss 17. What needs illustration is that in the embodiment, the removable functional module 2 is embedded into the embedded power supply bin 11, and when the power supply connected spring needle groove 20 is matched and plugged with the charging interface 12 in the charging bin, the guide limit groove 21 is matched and plugged with the guide limit boss 17, so that the functions of guide plugging and stable charging connection are achieved, and the usability and stability are improved.

In some improved embodiments, the dimensions of the guide limit boss 17 are gradually increased towards the bottom of the embedded charging bin to form an inclined slope boss. The shape of the guide limit groove 21 is adapted to the change of the inclined slope boss. What needs illustration is that in the embodiment, the dimensions of the guide limit boss 17 are gradually increased towards the bottom of the embedded charging bin to form an inclined slope boss. The shape of the guide limit groove 21 is adapted to the change of the inclined slope boss, so that the usability and stability of plugging are further improved.

In some improved embodiments, a limit spring 18 is arranged at the bottom of the embedded power supply bin. The removable functional module 2 is embedded into the embedded power supply bin 11. When the power supply connected spring needle groove 20 is matched and plugged with the charging interface 12 in the charging bin, the limit spring 18 performs charging connection limit on the removable functional module 2. What needs illustration is that in the embodiment, the removable functional module 2 is embedded into the embedded power supply bin 11, and when the power supply connected spring needle groove 20 is matched and plugged with the charging interface 12 in the charging bin, the limit spring 18 performs charging connection limit on the removable functional module 2, so that the charging connection offset is avoided, and the stability of charging connection is further improved.

### Embodiment II

Referring to FIG. 1 to FIG. 12, the embodiment provides a multifunctional mobile power supply, including a power supply host machine 1. The power supply host machine 1 includes an embedded power supply bin 11 and a removable functional module 2. The embedded power supply bin 11 includes a charging interface 12 in a charging bin. The removable functional module 2 includes a power supply connected spring needle groove 20, and when the power supply connected spring needle groove 20 is matched and plugged with the charging interface 12 in the charging bin, the removable functional module 2 is embedded into the embedded power supply bin 11 for charging and can work independently.

What needs illustration is that in the embodiment, the embedded power supply bin 11 includes a charging interface 12 in a charging bin. The embedded power supply bin 11 is used for providing embedded charging for a removable functional module 2. The removable functional module 2 includes a power supply connected spring needle groove 20. The power supply connected spring needle groove 20 can be matched and plugged with the charging interface 12 in the charging bin, so that the removable functional module 2 is charged. The removable functional module 2 and the mobile power supply are connected without the need of a charging cable, so that charging management is facilitated. In addition, the removable functional modules 2 with different functions are embedded in the power supply host machine 1 for charging, and the mobile power supply 2 charges the removable functional modules 2 and also has the functions of the removable functional modules, so that one power supply host machine 1 can be matched with the removable functional modules 2 with different functions to obtain mobile power supplies with different functions.

### Embodiment III

The embedded power supply bin 11 of the power supply host machine 1 is embedded with a spliced panel light module and a spliced spotlight module for charging. The mobile power supply can have a panel light function and a spotlight function, but the embedded power supply bin 11 embedded with a spliced panel light module and a spliced spotlight module for charging has shortcomings when a light source needs to be supported at a higher position for lighting. Due to the limitation of the number of the embedded power supply bins 11, the numbers of spliced panel light modules and spliced spotlight modules is limited to a certain extent, and then the illumination area is limited. At the same time, spliced panel light modules and spliced spotlight modules are embedded in an excessive number of embedded power supply bins 11, resulting in the limitation of the combination of other removable functional modules 2. Thus, the embodiment provides a spliced lamp module support. The spliced lamp module support can be plugged with a support plugged position 19 arranged on the power supply host machine 1. Referring to FIG. 1 to FIG. 12, the spliced lamp module support provided by the embodiment includes:
a support body 50, wherein the support body 50 is used for supporting the spliced lamp module on the support plugged position 19 arranged on the power supply host machine 1; the spliced lamp module includes a lamp module body 3, a control board and a light-emitting device 31 are assembled inside the lamp module body 3, the light-emitting device 31 is electrically connected with the control board, and light emitted by the light-emitting device 31 is emitted from a first body surface of the lamp module body 3; a power supply connected spring needle groove 20 is formed in a second body surface of the lamp module body 3, the power supply connected spring needle groove 20 is used for being matched and plugged with a power supply interface of an external power supply to supply power to the control board and the light-emitting device 31, and the second body surface of the lamp module body 3 and the first body surface of the lamp module body 3 are opposite to each other; a third body surface of the lamp module body 3 is provided with a lamp module boss 32, a lamp module groove 33 is formed in a fourth body surface of the lamp module body 3, and the third body surface of the lamp module body 3 and the fourth body surface of the lamp module body 3 are opposite to each other; the lamp module groove 33 and the lamp module boss 32 can be matched and plugged to splice a plurality of spliced lamp modules into a whole;
a lamp module mounting platform 51, wherein the lamp module mounting platform 51 is assembled on the support body 50; the lamp module mounting platform 51 is provided with a platform groove 510 and/or a platform boss 32, and is used for being matched and plugged with the lamp module groove 33 and/or the lamp module boss 32 to fix the spliced lamp module.

What needs illustration is that in the embodiment, the spliced lamp module support can be used with the spliced lamp module to obtain a novel spliced lamp. Without depending on a power supply line, the power supply connected spring needle groove 20 is matched and plugged with the power supply interface of the external power supply, and the new spliced lamp can supply power to the control board and the light-emitting device 31 so as to realize illumination. The spliced lamp module can be used as an independent module for illumination, and the lamp modules can be spliced freely for illumination expansion. In addition, the lamp module mounting platform 51 is assembled on the support body 50. The lamp module mounting platform 51 is provided with a platform groove 510 and/or a platform boss 32, and is used for being matched and plugged with the lamp module groove 33 and/or the lamp module boss 32 to fix the spliced lamp module, so that free spliced matching of the spliced lamp module and the spliced lamp module support is realized for illumination expansion. For example, a larger illumination area is obtained, and illumination choices in different directions are obtained.

In some preferred embodiments, the support body 50 includes a segmented body 500 and an adjustment mounting head 501. The segmented body 500 is connected to the bottom of the adjustment mounting head 501, and the lamp module mounting platform 51 is assembled on the top of the adjustment mounting head 501. Adjustment mounting is used for adjusting the length of the segmented body 500. What needs illustration is that in the embodiment, the segmented body 500 is connected to the bottom of the adjustment mounting head 501, and the lamp module mounting platform 51 is assembled on the top of the adjustment mounting head 501. The adjustment mounting is used for adjusting the length of the segmented body 500, so that the height of the support required for illumination can be freely adjusted.

In some preferred embodiments, the lamp module mounting platform 51 is provided with a platform groove 510, or a platform boss, or a plurality of platform grooves 510, or a plurality of platform bosses, or any number of platform grooves 510 and platform bosses. What needs illustration is that in the embodiment, the lamp module mounting platform 51 is provided with a platform groove 510, or a platform boss, or a plurality of platform grooves 510, or a plurality of platform bosses, or any number of platform grooves 510 and platform bosses, so that the lamp modules can be freely spliced by a user conveniently to obtain a novel lamp.

### Embodiment IV

Referring to FIG. 1 to FIG. 12, the embodiment of the present disclosure provides a spliced lamp module, including a lamp module body 3, a power supply connected spring needle groove 20, a lamp module boss 32 and a lamp module groove 33. A control board and a light-emitting device 31 are assembled inside the lamp module body 3, the light-emitting device 31 is electrically connected with the control board, and light emitted by the light-emitting device 31 is emitted from a first body surface of the lamp module body 3. The power supply connected spring needle groove 20 is formed in a second body surface of the lamp module body 3 and used for being matched and plugged with a power supply interface of an external power supply to supply power to the control board and the light-emitting device 31, and the second body surface of the lamp module body 3 and the first body surface of the lamp module body 3 are opposite to each other. The lamp module boss 32 is arranged on a third body surface of the lamp module body 3, and when the lamp module boss 32 is plugged with other lamp modules, different lamp modules are spliced into a whole. The lamp module groove 33 is formed in a fourth body surface of the lamp module body 3, when the lamp module groove 33 is plugged with other lamp modules, different lamp modules are spliced into a whole, and the third body surface of the lamp module body 3 and the fourth body surface of the lamp module body 3 are opposite to each other. What needs illustration is that in the embodiment, a control board and a light-emitting device 31 are assembled inside the lamp module body 3, the light-emitting device 31 is electrically connected with the control board, and light emitted by the light-emitting device 31 is emitted from a first body surface of the lamp module body 3. The power supply connected spring needle groove 20 is formed in a second body surface of the lamp module body 3 and used for being matched and plugged with a power supply interface of an external power supply to supply power to the control board and the light-emitting device 31, and the second body surface of the lamp module body 3 and the first body surface of the lamp module body 3 are opposite to each other. Therefore, the lamp module does not depend on a power supply line or an external adapter, the power supply connected spring needle groove 20 is matched and plugged with the power supply interface of the external power supply, and power can be supplied to the control board and the light-emitting device 31 so as to realize illumination. In addition, the lamp module boss 32 is arranged on a third body surface of the lamp module body 3, and when the lamp module boss 32 is plugged with other lamp modules, such as when the lamp module boss 32 is plugged with lamp module grooves 33 of other lamp modules, different lamp modules are spliced into a whole. The lamp module groove 33 is formed in a fourth body surface of the lamp module body 3, when the lamp module groove 33 is plugged with other lamp modules, such as when the lamp module groove 33 is plugged with lamp module bosses 32 of other lamp modules, different lamp modules are spliced into a whole, and the third body surface of the lamp module body 3 and the fourth body surface of the lamp module body 3 are opposite to each other. Therefore, the spliced lamp module can be used as an independent module for illumination, and the lamp modules can be spliced freely through the lamp module boss 32 and the lamp module groove 33 for illumination expansion. Wherein, the spliced lamp modules include spotlight modules and panel lamp modules.

### Embodiment V

Referring to FIG. 1 to FIG. 12, the embodiment of the present disclosure provide a spliced lamp. The spliced lamp includes a spliced lamp module support as described in any of the above embodiments. The spliced lamp also includes the spliced lamp module, and the spliced lamp module is assembled on the spliced module support.

### Embodiment VI

Referring to FIG. 1 to FIG. 12, the embodiment of the present disclosure provides a spliced mobile power supply module, including a power supply module body 4, a charging boss, a magnetic attraction spliced assembly and a power supply connected spring needle groove 20. A PCB control board and a battery unit are assembled inside the power supply module body 4, and the battery unit is electrically connected with the PCB control board. The charging boss is arranged on the first body surface of the power supply module body 4, is electrically connected with the PCB control board, and is used for being matched and plugged with the power supply connected spring needle groove 20 of the removable functional module 2 to charge the removable functional module 2. The magnetic attraction spliced assembly is arranged on the first body surface of the power supply module body 4, and is used for splicing and adsorbing the mobile power supply module to a setting surface of the power supply connected spring needle groove 20 of the removable functional module 2. The power supply connected spring needle groove 20 of the spliced mobile power supply module is arranged on the second body surface of the power supply module body 4, is electrically connected with the PCB control board, and is used for being matched and plugged with the charging interface 12 in the charging bin to charge the battery unit. The second body surface of the power supply module body 4 and the first body surface of the power supply module body 4 are opposite to each other. Wherein, the power supply connected spring needle groove 20 of the removable functional module 2 can include charging spring needles and a charging groove, and the charging spring needles are distributed in the charging groove.

What needs illustration is that in the embodiment, the charging boss is arranged on the first body surface of the power supply module body 4, is electrically connected with the PCB control board, and is used for being matched and plugged with the power supply connected spring needle groove 20 of the removable functional module 2 to charge the removable functional module 2, so that the spliced mobile power supply module can be freely spliced and charged with the removable functional module 2 as an independent module without depending on a charging cable. In addition, the magnetic attraction spliced assembly is arranged on the first body surface of the power supply module body 4, and is used for splicing and adsorbing the mobile power supply module to the setting surface of the power supply connected spring needle groove 20 of the removable functional module 2, so that the spliced mobile power supply module and the removable functional module 2 can be adsorbed into a whole. It is ensured that the power supply connected spring needle groove 20 and the charging boss are tightly connected to realize charging, and the removable functional module 2 and the spliced mobile power supply module are mutually supported without another position to place the spliced mobile power supply module, so that the space is saved, and the device is convenient to use. In addition, the power supply connected spring needle groove 20 of the spliced mobile power supply module is arranged on the second body surface of the power supply module body 4, is electrically connected with the PCB control board, and is used for being matched and plugged with the charging interface 12 in the charging bin to charge the battery unit, so that the spliced mobile power supply module can be freely spliced with the external power supply as an independent module to charge without depending on a charging cable.

In some preferred embodiments, the charging boss includes a boss surface 41, a charging hole 42 and a charging spring plate 43. The charging hole 42 and the charging spring p late 43 are distributed on the boss surface 41. The charging spring plate 43 is located in the charging hole 42 and electrically connected with the PCB control board. What needs illustration is that in the embodiment, the charging boss includes a boss surface 41, a charging hole 42 and a charging spring plate 43. The charging hole 42 and the charging spring p late 43 are distributed on the boss surface 41, so that the spliced mobile power supply module and the removable functional module 2 can be adsorbed into a whole. It is ensured that the power supply connected spring needle groove 20 of the removable functional module 2 and the charging surface 41 of the charging boss are tightly connected to realize charging, and the removable functional module 2 and the spliced mobile power supply module are mutually supported without another position to place the spliced mobile power supply module, so that the space is saved, and the device is convenient to use. In some preferred embodiments, the magnetic attraction spliced assembly includes a first magnet, a second magnet, a third magnet and a fourth magnet. The first magnet, the second magnet, the third magnet and the fourth magnet are distributed at four different positions on the first body surface of the power supply module body 4 so as to surround the charging boss. What needs illustration is that in the embodiment, the first magnet, the second magnet, the third magnet and the fourth magnet are distributed at four different positions on the first body surface of the power supply module body 4 so as to surround the charging boss, so that the setting surface of the charging boss of the spliced mobile power supply module can be tightly connected with the setting surface of the power supply connected spring needle groove 20 of the removable functional module 2 to realize charging. Moreover, the removable functional module 2 and the spliced mobile power supply module are mutually supported without another position to place the spliced mobile power supply module, so that the space is saved, and the device is convenient to use.

What is claimed is:

1. A multifunctional mobile power supply, comprising a power supply host machine, wherein the power supply host machine comprises an embedded power supply bin, and the embedded power supply bin comprises a charging interface in a charging bin; the embedded power supply bin is used for providing embedded charging for a removable functional module; and the removable functional module comprises a power supply connected spring needle groove, and when the power supply connected spring needle groove is matched and plugged with the charging interface in the charging bin, the removable functional module is embedded into the embedded power supply bin for charging and can work independently.

2. The multifunctional mobile power supply according to claim 1, wherein the embedded power supply bin refers to a plurality of embedded power supply bins; the embedded power supply bins are distributed on one side of the power supply host machine at intervals; body structures of the removable functional modules are completely embedded into the embedded power supply bins, or the body structures of the removable functional modules are partially embedded into the embedded power supply bins.

3. The multifunctional mobile power supply according to claim 2, wherein the removable functional modules comprise a spliced mobile power supply module, a spliced panel light module, a spliced spotlight module, a spliced Bluetooth audio and a spliced USB (Universal Serial Bus) module.

4. The multifunctional mobile power supply according to claim 3, also comprising an audio module, wherein the audio module comprises an audio control circuit and a loudspeaker; the audio control circuit is integrated on a control circuit board of the power supply host machine and electrically connected with the loudspeaker; and the loudspeaker is arranged on the inner side of the power supply host machine and communicates with an outer wall of the power supply host machine.

5. The multifunctional mobile power supply according to claim 3, also comprising an intelligent speech recognition module, wherein the intelligent speech recognition module comprises a microphone and an intelligent speech recognition circuit, the intelligent speech recognition circuit is integrated on the control circuit board of the power supply host machine and electrically connected with the microphone; and the microphone is arranged on the inner side of the power supply host machine and communicates with an outer wall of the power supply host machine.

6. The multifunctional mobile power supply according to claim 5, wherein the intelligent speech recognition circuit comprises an intelligent speech recognition chip, the intelligent speech recognition chip prestores an instruction for controlling to open or close the charging interface in the charging bin; the microphone receives a speech signal that a user controls to open or close the charging interface in the charging bin and transmits the speech signal to the intelligent speech recognition chip, and the intelligent speech recognition chip controls to open or close the charging interface in the charging bin after the speech signal is matched with the instruction of opening or closing the charging interface in the charging bin.

7. The multifunctional mobile power supply according to claim 4, wherein when the control circuit board of the power supply host machine obtains a signal that the removable functional module is connected or disconnected with the charging interface in the charging bin, ID (identity) information of the removable functional module is connected or disconnected with the charging interface in the charging bin is judged, and the audio module is controlled to broadcast a connection state or a disconnection state of the removable functional module according to the judged ID information.

8. The multifunctional mobile power supply according to claim 1, wherein the removable functional module is cuboid-shaped, and the embedded power supply bin is a cuboid-shaped empty bin.

9. The multifunctional mobile power supply according to claim 1, wherein the removable functional module also comprises a guide limit groove, and the guide limit groove is arranged on the outer side of the removable functional module; the embedded power supply bin is internally provided with a guide limit boss; the removable functional module is embedded into the embedded power supply bin, and when the power supply connected spring needle groove is matched and plugged with the charging interface in the charging bin, the guide limit groove is matched and plugged with the guide limit boss.

10. A multifunctional mobile power supply, comprising:
a power supply host machine, wherein the power supply host machine comprises an embedded power supply bin, and the embedded power supply bin comprises a charging interface in a charging bin; and
a removable functional module, wherein the removable functional module comprises a power supply connected spring needle groove, and when the power supply connected spring needle groove is matched and plugged with the charging interface in the charging bin, the removable functional module is embedded into the embedded power supply bin for charging and can work independently.
